(19) United States
(12) Patent Application Publication
(10) Pub. No.: US 2009/0083185 A1
(43) Pub. Date: Mar. 26, 2009

(54) Reassigning toll violation information

(75) Inventors: Benjamin P. Robinson, Plano, TX (US); Sarath K. Balachandran, Irving, TX (US)

Correspondence Address: Raffi Gostanian, Jr.;RG&Associates, Ste. 120, 1103 Twin Creeks, Allen, TX, 75013, US

(73) Assignee: Rent-A-Toll, Ltd., Plano, TX (US)

(21) Appl. No.: 11/903,687

(22) Filed: Sep. 24, 2007

(51) Int. Cl. G07B 15/00; H04K 1/00

(52) U.S. Cl. 705/50; 705/13

(57) ABSTRACT

A method, system, and computer readable medium for reassigning toll violation information comprises receiving, by a toll rental entity, toll usage information from a toll authority, wherein the toll usage information includes toll violation information, receiving, by the third party entity, the toll usage information from the toll rental entity, matching, by the third party entity, transport user information to the toll usage information, receiving, by the toll rental entity, the matched information, from the third party entity, receiving, by a toll authority, the matched information, from the toll rental entity, and reassigning, by the toll authority, a responsibility for the toll violation from the third party entity to a transport user.

### CROSS-REFERENCE TO RELATED APPLICATIONS

The present patent application is related to U.S. patent application docket number RTL032, filed Jun. 7, 2007, entitled Providing Toll Services Utilizing A Cellular Device, U.S. Provisional Patent Application No. 60/757,406, titled Online Travel Provider Toll System And Method, filed on Jan. 9, 2006, U.S. Provisional Patent Application No. 60/757,347, titled Electronic Toll Payment System And Method For Third Party Operated Vehicles Utilizing An Onboard Unit, filed on Jan. 9, 2006, U.S. Provisional Patent Application No. 60/757,405, titled GPS Toll System And Method For Collection Of Rental Vehicle Tolls, filed on Jan. 9, 2006, U.S. Provisional Patent Application No. 60/726,300, titled Toll Fee System And Method Using Prepaid Toll Pass, filed on Oct. 13, 2005, U.S. Provisional Patent Application No. 60/759,937, titled Business Process For Toll Fee System And Method For Vehicle Registration, Invoicing, Opt-In Services, And Toll Violations, filed on Jan. 18, 2006, U.S. Provisional Patent Application No. 60/763, 097 titled Method And System For Toll Collection With Optional Service Capabilities, filed on Jan. 27, 2006, U.S. Non-Provisional patent application Ser. No. 11/125,521, titled Toll Fee System And Method, filed on May 10, 2005, to U.S. Non-Provisional Patent Application Docket No. RTL008, titled System, Method, And Computer Readable Medium For Billing, filed on Sep. 6, 2006, to U.S. Non-Provisional Patent Application Docket No. RTL009, titled System, Method, And Computer Readable Medium For Billing Tolls, filed on Sep. 6, 2006, to U.S. Non-Provisional Patent Application Docket No. RTL010, titled System, Method And Computer Readable Medium For Toll Service Activation And Billing, filed on Oct. 13, 2006, to U.S. Non-Provisional Patent Application Docket No. RTL010A, titled System, Method And Computer Readable Medium For Billing Based On A Duration Of A Service Period, filed on Oct. 13, 2006, to U.S. Non-Provisional Patent Application Docket No. RTL030, tilted Paying Tolls Utilizing A Financial Service Provider And Paying A Subscription Or License Fee, filed on Dec. 18, 2006, to U.S. Non-Provisional patent application Ser. No. 11/640,586, titled Transferring Toll Data From A Third Party Operated Transport To A User Account, filed on Dec. 18, 2006, and to U.S. Non-Provisional Patent Application Docket No. RTL031, titled Determining A Toll Amount, filed on May 16, 2007 the entire contents of each of which are incorporated by reference herein.

### BACKGROUND OF THE INVENTION

The present invention relates generally to toll services and, more particularly, but not by way of limitation, to a method, system, and computer readable medium for reassigning toll violation information.

Currently, when a vehicle commits a toll violation a lengthy, manual and complicated process ensues in an attempt to rectify the violation. For example, a vehicle may pass through a toll booth and not pay the requisite amount. Such an action would typically constitute a toll violation. A toll authority would then have to identify the vehicle and an owner of the vehicle, and would send a violation notice to the owner. In situations where an individual rents a vehicle and commits a toll violation, the ability to correct the violation is even more difficult as the rental agency must get involved in order to provide information that is present on a rental agreement between the individual and the rental agency. For example, the rental agreement would have to be physically pulled and the task of collection transferred to the toll authority.

As such, it is desirable to automate the capture and delivery of toll violation information in order to overcome the complexities and limitations described above.

### SUMMARY OF THE INVENTION

The present invention provides a method, system, and computer readable medium for reassigning toll violation information. In one embodiment, a method for reassigning toll violation information comprises receiving, by a toll rental entity, toll usage information from a toll authority, wherein the toll usage information includes toll violation information, receiving, by the third party entity, the toll usage information from the toll rental entity, matching, by the third party entity, transport user information to the toll usage information, receiving, by the toll rental entity, the matched information, from the third party entity, receiving, by a toll authority, the matched information, from the toll rental entity, and reassigning, by the toll authority, a responsibility for the toll violation from the third party entity to a transport user.

In another embodiment, a computer readable medium comprises instructions for: receiving, by a third party entity, toll usage information from a toll authority, wherein the toll usage information includes toll violation information, matching, by the third party entity, transport user information to the toll usage information, receiving, by a toll authority, the matched information, from the third party entity, and reassigning, by the toll authority, a responsibility for the toll violation from the third party entity to a transport user.

In a further embodiment, a system for reassigning toll violation information, comprises a third party entity and a toll authority, wherein the third party entity and the toll authority are communicably coupled, wherein the toll authority collects toll usage information, wherein the toll usage information includes toll violation information, wherein the toll authority matches transport user information to the toll usage information, and wherein the toll authority reassigns a responsibility for the toll violation from the third party entity to a transport user.

### BRIEF DESCRIPTION OF THE DRAWINGS

FIG. 1 illustrates a first system diagram and message flow according to an embodiment of the disclosure;

FIG. 2 illustrates a second system diagram and message flow according to an embodiment of the disclosure;

FIG. 3 illustrates a third system diagram and message flow according to an embodiment of the disclosure;

FIG. 4 illustrates a first flow chart according to an embodiment of the disclosure;

FIG. 5 illustrates a second flow chart according to an embodiment of the disclosure;

FIG. 6 illustrates a third flow chart according to an embodiment of the disclosure;

FIG. 7 illustrates a fourth flow chart according to an embodiment of the disclosure;

FIG. 8 illustrates a fifth flow chart according to an embodiment of the disclosure;

FIG. 9 illustrates a process diagram according to an embodiment of the disclosure;

FIG. 10 illustrates a sixth flow chart according to an embodiment of the disclosure;

FIG. 11 illustrates a fourth system diagram and message flow according to an embodiment of the disclosure; and

FIG. 12 illustrates a fifth system diagram and message flow according to an embodiment of the disclosure.

### DETAILED DESCRIPTION OF THE INVENTION

Embodiments of the present invention provide a system, method, and computer readable medium for reassigning toll violation information in an automated manner. Currently, toll violations for rental cars are sent directly to a fleet vehicle owner. In order for the fleet owners to relive themselves of responsibility for those violations incurred, they manually account for an individual who was driving the car or who the car was rented to at the time of the violation. The fleet owners then produce a rental contract to a Toll Authority where the violation occurred and hope the Toll Authority has the resources to effectively collect payments and potential penalties associated with the violation. As such, the manual processing of violations for rental agencies, parking authorities, tolling authorities, etc. is eliminated as is the need to physically pull and copy a rental agreement for reassignment to the toll authority in order to effectuate the transfer of responsibility from the fleet owners to the toll authority.

In one embodiment of the present invention, a toll service system reassigns violation responsibility from rental agencies or fleet vehicle owners to individual renters or users of a transport such as a vehicle, bus, motorcycle, train, boat., and any object able to transport an individual. The system allows for an automated transmission of toll usage information from a toll authority to a fleet vehicle owner so that the fleet owner can reassign the violation responsibility to an individual who was using the vehicle and/or who rented the vehicle at the time the violation occurred. This removes liability from the fleet owner and provides the actual user information necessary to collect per the violation with the toll authority.

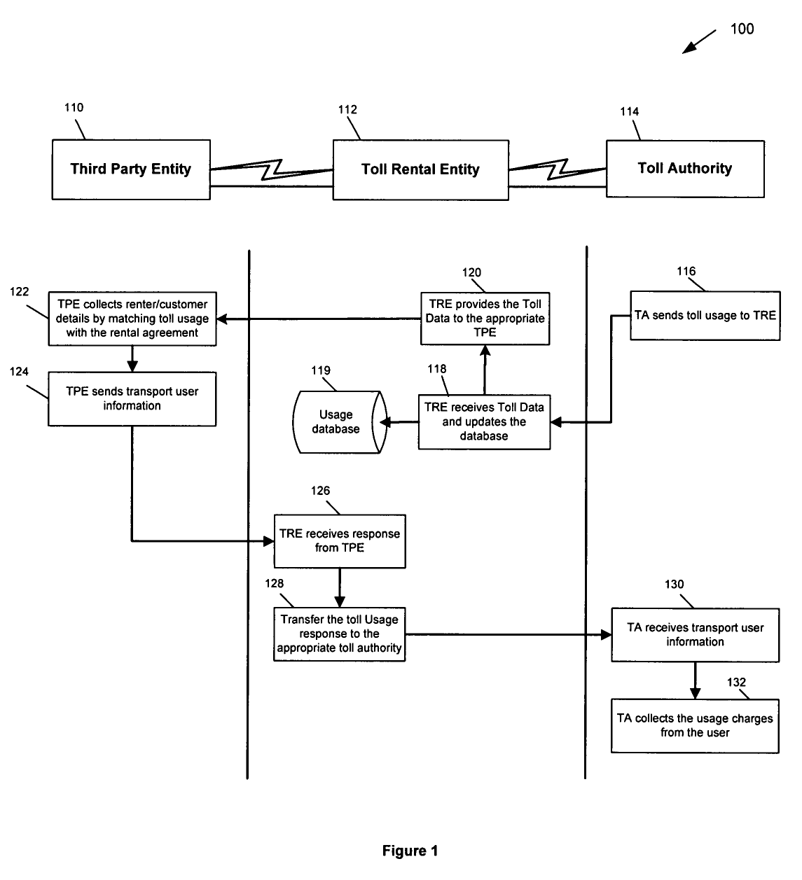

Referring now to FIG. 1, a system 100 includes a third party entity 110, a toll rental entity 112, and a toll authority 114 which are communicably coupled to one another via a wired connection, a wireless connection, and/or a combination of the two. In other embodiments, the third party entity 110 can communicate directly with the toll authority 114. The toll authority 114 sends 116 the toll usage to the toll rental entity 112 periodically via a wired or wireless communication. The toll rental entity 112 receives and/or validates 118 the data, format, and content, based on the toll authority origination. Each toll authority 114 might send the data in a different format or standard and at a different time. The toll rental entity 112 categories the data received from the toll authorities and saves that information in a database 119 such as a usage database.

The toll rental entity 112 matches the toll usage to vehicle owned or operated by the third party entity 110 and transfers the toll usage to the third party entity periodically via any manner such as FTP, HTML, web services, wireless, etc. The third party entity 110 receives the toll usage from the toll rental entity 112 and matches 122 vehicle information and toll usage information. The third party entity 110 uses information such as a license plate number, an on-board unit identifier, a vehicle identification number, and the like to identify the vehicle. Once the vehicle is identified, the transport rental information is matched against a toll usage time or timestamp. If the toll usage time is equivalent to or within a time associated with a transport rental agreement, the third party entity 110 sends 124 the third party transport renter or user information to the toll rental entity 112 in real time or in batch. If third party entity 110 could not match the rental agreement, then the third party entity pays for the toll usage or it sends the transport user information to the toll rental entity 112. The toll rental entity 112 receives 126 the response from the third party entity 110 and transfers 128 the response to the appropriate toll authority 116. The toll authority 116 receives 130 the user information and collects 132 the payment for the toll usage from the actual transport user or owner. The toll authority 116 may have a user account available for the payment to be made against or contact and collects the payments directly from the user. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

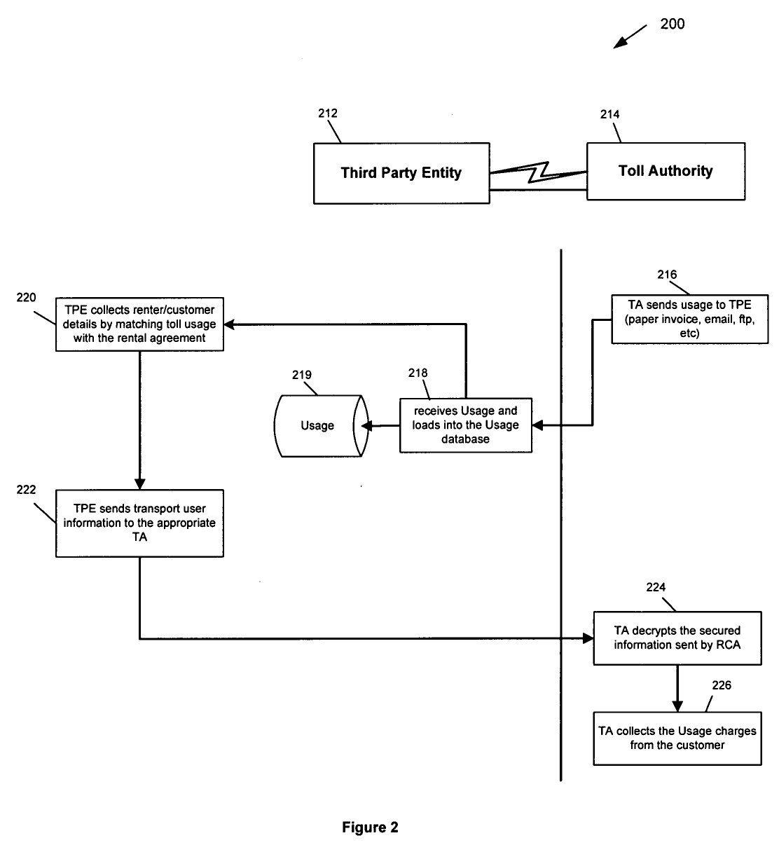

Referring now to FIG. 2, a system 200 includes a third party entity 212 and a toll authority 214 which are communicably coupled to one another via a wired connection, a wireless connection, and/or a combination of the two. In other embodiments, another entity or plurality of entities (not shown) can communicate directly with the toll authority 314 and/or the third party entity 316 to provide the embodiments depicted and described in this figure. A customer or transport owner/operator (not shown) can also communicate directly with any of the above noted entities). The toll authority 214 collects toll usage information from a toll plaza, toll lane, or other toll structure and sends 216 the toll usage information to the third party entity 212 by matching the vehicle registration information from the local database, using department of motor vehicle records, and the like. If the third party entity 212 periodically sends the vehicle information to the toll authority 214, then the toll authority 214 may avert using other sources for this information (such as the department of motor vehicles).

The third party entity 212 receives 218 the toll usage from the toll authority using any of the following mechanism: FITP, SMTP, web services, postal service, printed paper, etc. The third party entity 212 uses an appropriate interface to convert the received information to the standard electronic formation such as XML, CSV, etc and loads that information in to a database 219 such as a usage database. The third party entity 212 can deploy a solution including an Optical Character Recognition (OCR) scanner to scan the printer usage notice from the toll authority 214 and organize the toll usage by categories such as toll authority name, location, incident type, etc. The third party entity 212 matches 220 vehicle information and toll usage information against the transport rental system. The third party entity 212 uses information such as license plate number, an on-board unit identifier, a vehicle identification number, and the like to identify the vehicle. Once the vehicle is identified, the transport rental information is matched against a toll usage time or timestamp. If the toll usage time is equivalent to or within a time associated with a transport rental agreement, the third party entity 110 sends 222 the third party transport renter or user information to the toll rental entity 112 in real time or in batch. If there are two usage times or instances from two different toll authorities, the third party entity 212 sends the response to both toll authorities. The third party entity 212 uses email, FTP, web services, postal service, and the like to communicate the response back to the toll authority. The communication channel can be dynamic and can vary based on the toll authority interface.

If the third party entity 212 could not match the rental agreement, then the third party entity pays for the toll usage or it sends the transport user information or any other information to the toll authority 214 or to another entity (not shown). The toll authority 214 receives 224 the user information and collects 226 the payment for the toll usage from the actual transport user or owner. The toll authority 116 may have a user account available for the payment to be made against or contact and collects the payments directly from the user. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

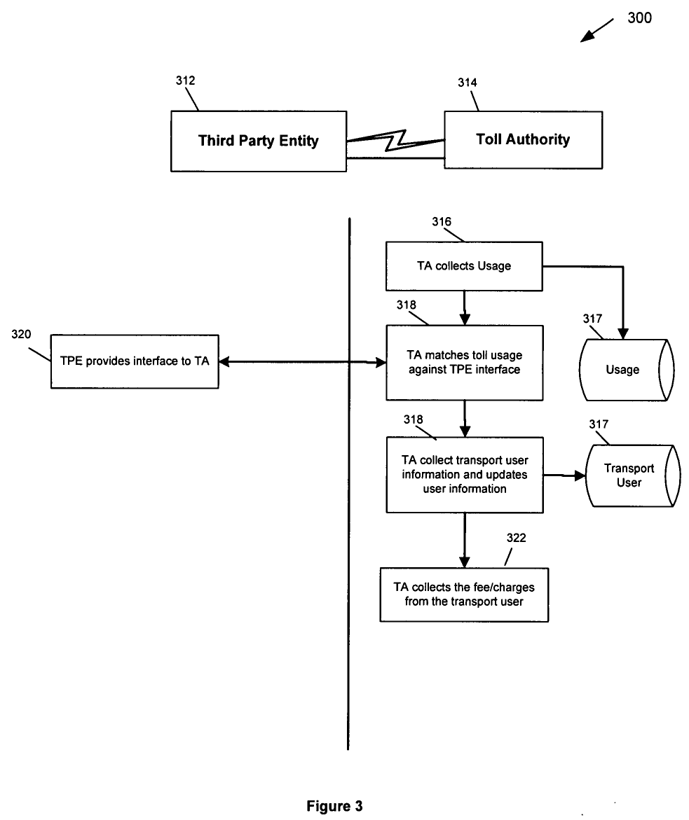

Referring now to FIG. 3, a system 300 includes a third party entity 312 and a toll authority 314 which are communicably coupled to one another via a wired connection, a wireless connection, and/or a combination of the two. In other embodiments, another entity or plurality of entities (not shown) can communicate directly with the toll authority 314 and/or the third party entity 312 to provide the embodiments depicted and described in this figure. A customer or transport owner/operator (not shown) can also communicate directly with any of the above noted entities).

The toll authority 314 collects 316 the toll usage received from a toll lane or other toll structure and stores this information in a database 317. The toll authority 314 matches 318 the toll usage against a transport reservation system owned and/or operated by the third party entity 312 using real time business to business communication interface such as service oriented architecture, EDI, etc. The toll authority 314 sends 320 the transport identifier, the toll usage location, the toll amount, the timestamp, etc. to the third party entity 316. The transport identifier can be at least one of the following: license plate number, on-board unit identifier, VIN, electronic VIN, and other transport identifier. The toll authority 314 matches the transport agreement and collects 318 and stores 317 the transport user information from the toll rental entity 316. The toll authority 314 receives the user information and collects 322 the payment for the toll usage from the actual transport user or owner. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

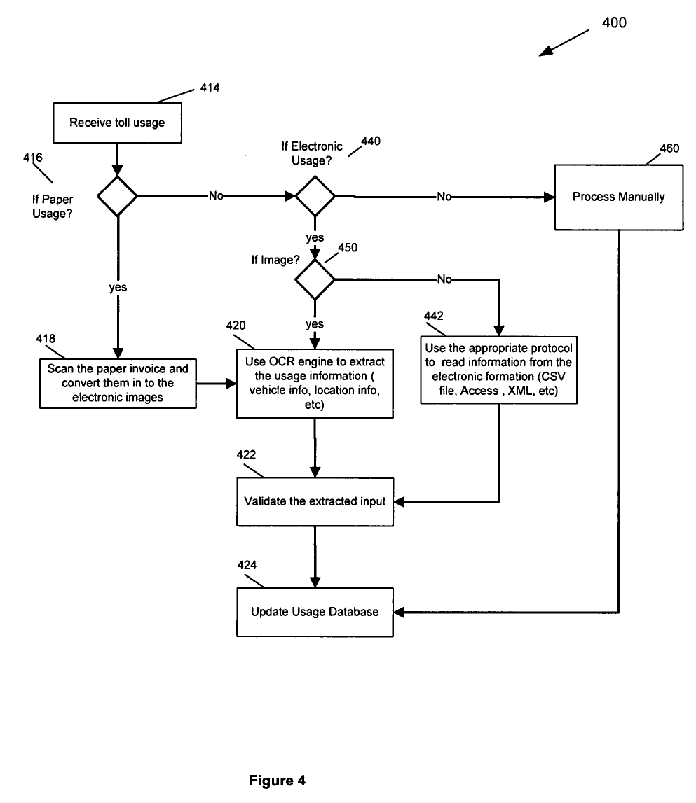

Referring now to FIG. 4, a method 400 for toll usage processing includes receiving 414 toll usage from an entity such as a toll authority or other entity or device via paper 416, electronic format 440 or if neither, is processed manually 460. If the toll usage is received through the paper 416, then the paper information (such as an invoice and the like), will be scanned 418 using a scanning device and converted to an image or electronic file. The scanned and converted output is sent 420 to an OCR scanner or other equipment. If the toll usage is received electronically 440, for example via an image 450, then the image is received 420 by the OCR scanner or other equipment. From either inputs 418 and 420, the usage information is extracted via a recognition module that extracts the content such as vehicle information, location information, toll amount, etc. The toll usage information may be sent in non-image form, for example, via an electronic format such as a Microsoft Excel spreadsheet, CSV, text file, XML etc. 442. The extracted information is validated 422 and is stored and/or updated 424 in a database. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

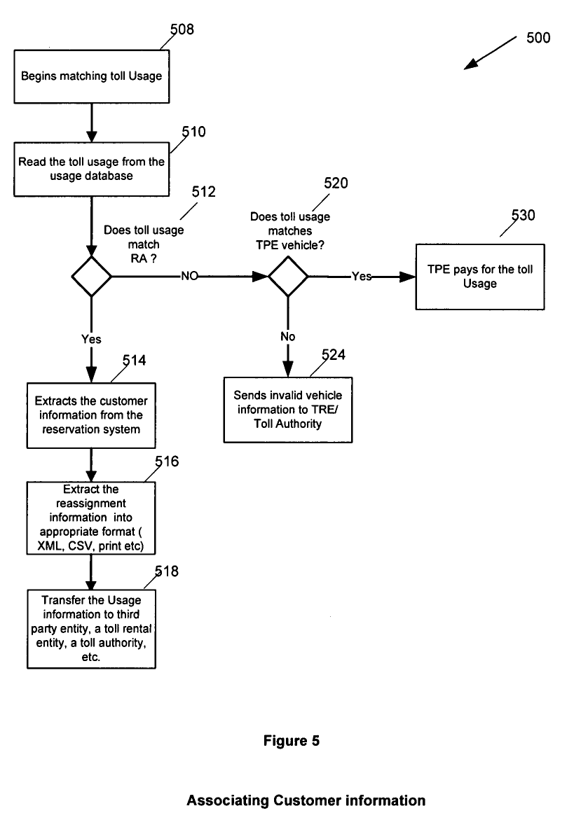

Referring now to FIG. 5, a flow chart 500 illustrates a process for associating customer information. Toll usage is matched 508 to at least one other piece of information (such as to a rented transport, a rented transport owner, to a location, to a timestamp, and the like). The toll usage is read 510 from a database and a check 512 is made to determine if the toll usage matches with a rental agreement. If it does, the customer information is extracted 514 from the reservation system, the reassignment information is extracted 516 and placed in an appropriate format, and the usage information is transferred 518 to a third part entity, a toll authority, and/or to another entity. If it does not, a check 520 is made to determine if the toll usage matches with a third party entity vehicle. If it does not, invalid vehicle information is sent 524 to a toll rental entity, to a toll authority, or to any other entity. If it does, the third party entity pays 530 for the toll usage. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

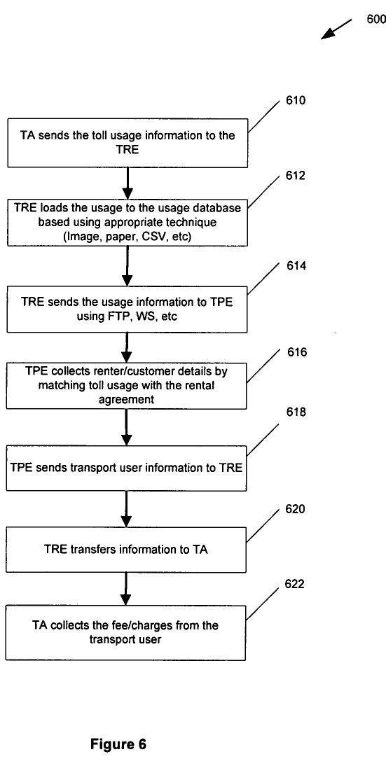

Referring now FIG. 6, a flow chart 600 for collecting compensation from a customer is depicted. A toll authority sends 610 toll usage information to a toll rental entity which loads 612 the usage information to a usage database using an appropriate technique, and sends 614 the usage information to a third party entity. The third party entity collects 616 renter or customer details by matching toll usage with a rental agreement, and sends 618 transport user information to the toll rental entity. The toll rental entity transfers 620 the information to the toll authority which collects 622 the charges and potential penalties from the renter or customer. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

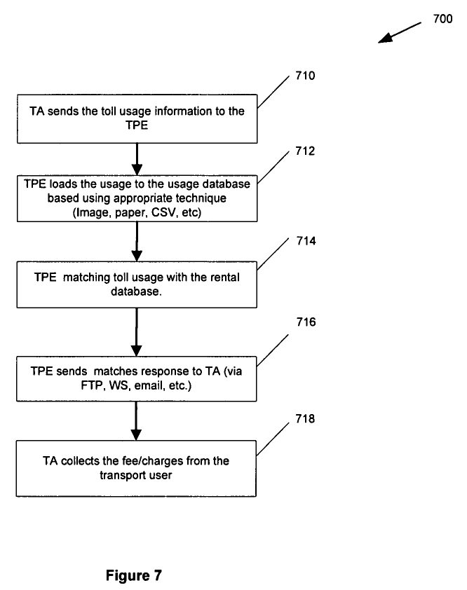

Referring now FIG. 7, a further flow chart 700 for collecting compensation from a customer is depicted. A toll authority sends 710 toll usage information to a third party entity which loads 712 the usage to a usage database using an appropriate technique. The third party entity matches 714 the toll usage with information in the rental database, and sends 716 any matches to the toll authority which collects 718 the charges and potential penalties from the renter or customer. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

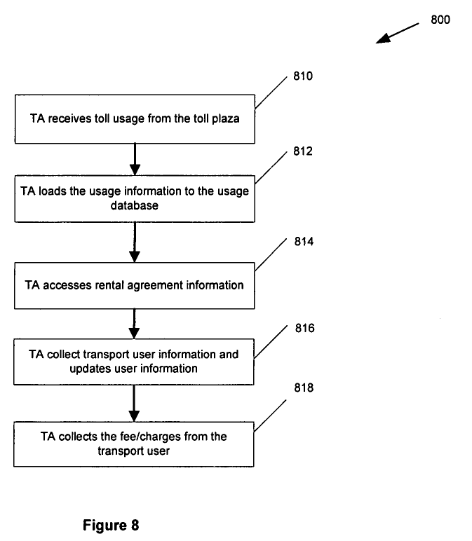

Referring now FIG. 8, a further flow chart 800 for collecting compensation from a customer is depicted. A toll authority receives 810 toll usage information from a toll plaza, loads 812 the usage to a usage database, accesses 814 rental agreement information (for example, via a third party entity interface), collects 816 transport user information and updates the user information, and collects 818 the charges and potential penalties from the renter or customer. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

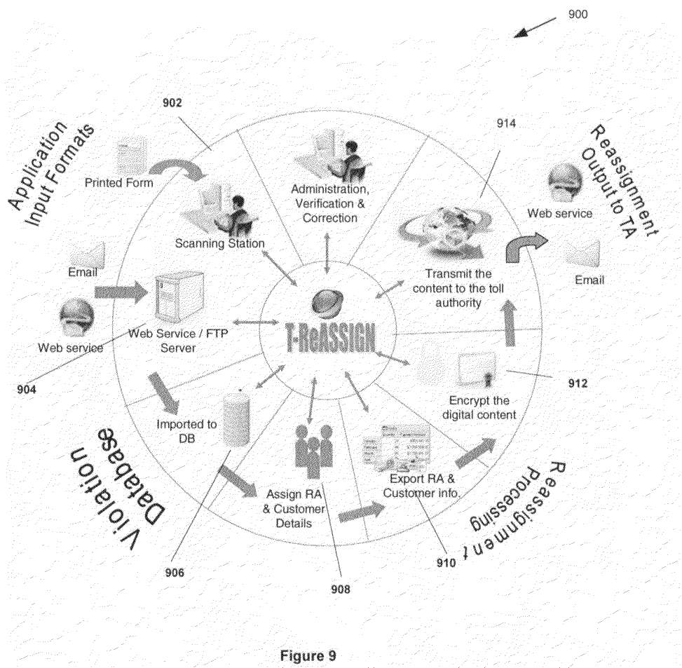

Referring now to FIG. 9, a toll reassignment the architecture diagram 900 is show. A printed form of toll usage is scanned 902 though a scanning station. Toll usage can also be received 904 electronically via email, FTP, etc. Received toll usage information is imported 906 to a toll usage database, and the toll usage is matched 908 against the transport rental system. Customer information and a rental agreement (RA) for the toll usage is exported 910 in any one of a number of formats such as XML, CSV, etc., and is encrypted 912 and sent 914 to a toll authority electronically or via a postal service. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

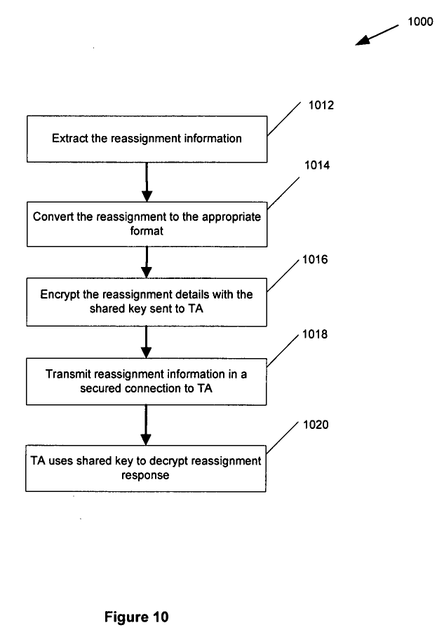

Referring now to FIG. 10, a toll reassignment flow chart 1000 is depicted. Reassignment information is extracted 1012, converted 1014 to an appropriate format, encrypted or otherwise secured 1016, transmitted 1018 to a toll authority which decrypts 1020 the reassignment. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

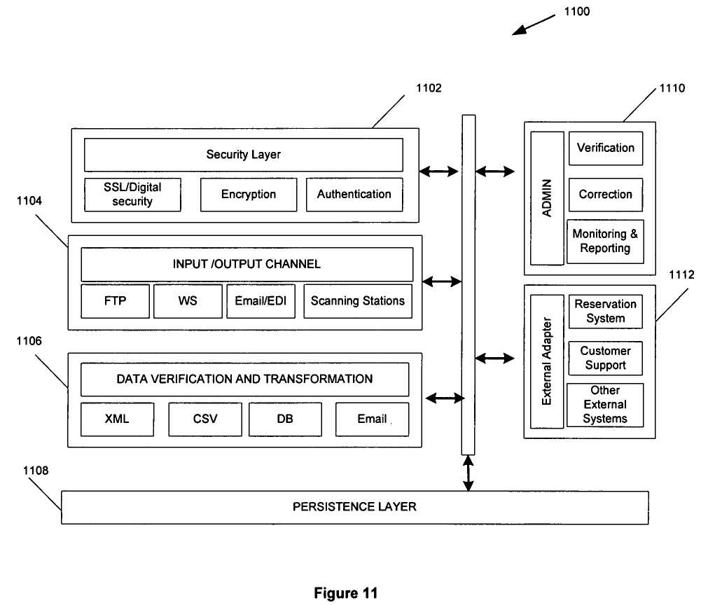

Referring now to FIG. 11, an architecture 1100 depicts the core components involved in the transfer of information or data as described herein. A security layer 1102 protects the data by implementing a mechanism such as Secure Socket Layer (SSL), digital certificate, encryption, and authentication. An input/output channel 1104, implements the mechanism utilizing FTP, web services, email, EDI, OCR, scanning station etc. and a data verification and transformation layer 1106, verifies the data correction and converts the data into an appropriate format such as XML, CSV, DB, email etc. A presentation layer 1108 is used to save the data to the database or read the information from the database and an external adapter layer 1112 is used to communicate with other systems such as a reservation system, a customer support system, and the like via a common protocol. An administration layer 1110 is used to monitor and report the system state and transaction.

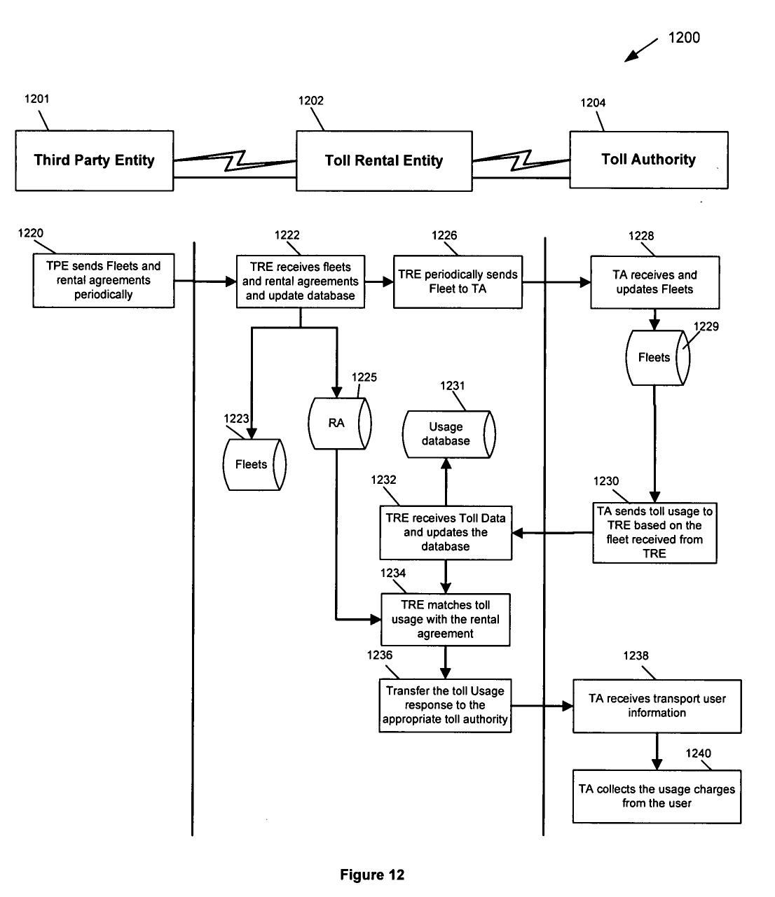

Referring now to FIG. 12, a system 1200 includes a third party entity 1201, a toll rental entity 1202, and a toll authority 1204 which are communicably coupled to one another via a wired connection, a wireless connection, and/or a combination of the two. In other embodiments, the third party entity 1201 can communicate directly with the toll authority 1204. The third party entity 1201 sends 1220 fleet and rental agreement information to the toll rental entity 1202 periodically via a wired or wireless communication. The toll rental entity 1202 receives and/or validates 1222 the data and updates one or more databases 1223, 1225. The toll rental entity 1202 matches 1234 the toll usage with the rental agreement and transfers 1236 the toll usage to the toll authority 1204 which receives 1238 the information and collects 1240 (or charges and collects) the usage charges (and potentially additional fees) from the user or customer.

Prior to the toll authority 1204 collecting the usage charges and potential additional fees, the toll rental entity 1202 sends 1226 the fleet information to the toll authority 1204 which receives and updates 1228 a database 1229. The toll authority 1204 sends 1230 the toll usage to the toll rental entity 1202 based on the sent 1226 information. The toll rental entity 1202 receives the toll data and updates 1232 a database 1231. The toll data is used as an input when the toll rental entity 1202 matches 1234 the toll usage with the rental agreement. The transfer of information in this figure occurs via at least one of: a wireless protocol, a wired protocol and a combination of the wireless protocol and the wired protocol. The steps in the flow are performed by software, hardware, firmware, and/or the combination of software, hardware, and/or firmware.

The present invention provides a method, system, and computer readable medium for reassigning toll violation information. In one embodiment, a method for reassigning toll violation information comprises receiving, by a toll rental entity, toll usage information from a toll authority, wherein the toll usage information includes toll violation information, receiving, by the third party entity, the toll usage information from the toll rental entity, matching, by the third party entity, transport user information to the toll usage information, receiving, by the toll rental entity, the matched information, from the third party entity, receiving, by a toll authority, the matched information, from the toll rental entity, and reassigning, by the toll authority, a responsibility for the toll violation from the third party entity to a transport user.

The method also comprises loading, by the toll rental entity, the toll usage information into a database based on a medium that the toll usage information was received, encrypting, by the third party entity, the transport user information, wherein the encrypted transport user information is matched to the toll usage information, providing, to an appropriate third party entity, the toll usage information, wherein the providing is based on a registered transport fleet of the toll rental entity, matching, by the toll rental entity, toll violation information with the registered transport fleet, wherein the transport is at least one of: an owned transport, a rented transport, a borrowed transport, a leased transport, and a fleet transport, wherein the toll usage information includes at least one of: transport information, incident information, violation information, timestamp, and location, wherein the transport user information includes at least one of: a user name, a residence address, a home address, a home phone number, an office phone number, a cell phone number, an email address, a credit card number, a bank card number, a social security number, a drivers license number, and a passport number.

In another embodiment, a computer readable medium comprises instructions for: receiving, by a third party entity, toll usage information from a toll authority, wherein the toll usage information includes toll violation information, matching, by the third party entity, transport user information to the toll usage information, receiving, by a toll authority, the matched information, from the third party entity, and reassigning, by the toll authority, a responsibility for the toll violation from the third party entity to a transport user.

The computer readable medium also comprises instructions for loading, by the third party entity, the toll usage information into a database based on a medium that the toll usage information was received, for encrypting, by the third party entity, the transport user information, wherein the encrypted transport user information is matched to the toll usage information, for providing, to an appropriate third party entity, the toll usage information, wherein the providing is based on a registered transport fleet of the toll rental entity, and for matching, by the third party entity, toll violation information with the registered transport fleet.

In a further embodiment, a system for reassigning toll violation information, comprises a third party entity and a toll authority, wherein the third party entity and the toll authority are communicably coupled, wherein the toll authority collects toll usage information, wherein the toll usage information includes toll violation information, wherein the toll authority matches transport user information to the toll usage information, and wherein the toll authority reassigns a responsibility for the toll violation from the third party entity to a transport user.

Within the system, the toll authority loads the toll usage information into a database based on a medium that the toll usage information was received, wherein the toll authority provides, to an appropriate transport user, the toll usage information, wherein the toll usage information is at least one of: a violation, a warning, and a monetary amount to pay, wherein the toll authority provides, to an appropriate transport owner, the toll usage information, wherein the toll usage information is at least one of: a violation, a warning, and a monetary amount to pay.

Although an exemplary embodiment of the system of the embodiment of the disclosure has been illustrated in the accompanied drawings and described in the foregoing detailed description, it will be understood that the embodiment of the disclosure is not limited to the embodiments disclosed, but is capable of numerous rearrangements, modifications, and substitutions without departing from the spirit of the embodiment of the disclosure as set forth and defined by the following claims. For example, the capabilities of the embodiments of the disclosure can be performed fully and/or partially by one or more of the described or depicted entities or devices. Also, these capabilities may be performed in the current manner or in a distributed manner and on, or via, any device able to provide and/or receive information. Further, although depicted in a particular manner, various modules or blocks may be repositioned without departing from the scope of the current embodiment of the disclosure. Still further, although depicted in a particular manner, a greater or lesser number of modules and connections can be utilized with the embodiments of the disclosure in order to accomplish the embodiments of the disclosure, to provide additional known features to the embodiments of the disclosure, and/or to make the embodiments of the disclosure more efficient. Also, the information sent between various modules can be sent between the modules via at least one of a data network, the Internet, an Internet Protocol network, a wireless source, and a wired source and via plurality of protocols.

What is claimed is:

1. A method for reassigning toll violation information, comprising:
receiving, by a toll rental entity, toll usage information from a toll authority, wherein the toll usage information includes toll violation information;
receiving, by the third party entity, the toll usage information from the toll rental entity;
matching, by the third party entity, transport user information to the toll usage information;
receiving, by the toll rental entity, the matched information, from the third party entity;
receiving, by a toll authority, the matched information, from the toll rental entity; and
reassigning, by the toll authority, a responsibility for the toll violation from the third party entity to a transport user.

2. The method of claim 1 comprising loading, by the toll rental entity, the toll usage information into a database based on a medium that the toll usage information was received.

3. The method of claim 1 comprising encrypting, by the third party entity, the transport user information.

4. The method of claim 3, wherein the encrypted transport user information is matched to the toll usage information.

5. The method of claim 1 comprising providing, to an appropriate third party entity, the toll usage information.

6. The method of claim 5, wherein the providing is based on a registered transport fleet of the toll rental entity.

7. The method of claim 6 comprising matching, by the toll rental entity, toll violation information with the registered transport fleet.

8. The method of claim 1, wherein the transport is at least one of:
an owned transport;
a rented transport;
a borrowed transport;
a leased transport; and
a fleet transport.

9. The method of claim 1, wherein the toll usage information includes at least one of:
transport information;
incident information;
violation information;
timestamp; and
location.

10. The method of claim 1, wherein the transport user information includes at least one of:
a user name;
a residence address;
a home address;
a home phone number;
an office phone number;
a cell phone number;
an email address;
a credit card number;
a bank card number;
a social security number;
a drivers license number; and
a passport number.

11. A computer readable medium comprising instructions for:
receiving, by a third party entity, toll usage information from a toll authority, wherein the toll usage information includes toll violation information;
matching, by the third party entity, transport user information to the toll usage information;
receiving, by a toll authority, the matched information, from the third party entity; and
reassigning, by the toll authority, a responsibility for the toll violation from the third party entity to a transport user.

12. The computer readable medium of claim 11 comprising instructions for loading, by the third party entity, the toll usage information into a database based on a medium that the toll usage information was received.

13. The computer readable medium of claim 11 comprising instructions for encrypting, by the third party entity, the transport user information.

14. The computer readable medium of claim 13, wherein the encrypted transport user information is matched to the toll usage information.

15. The computer readable medium of claim 11 comprising instructions for providing, to an appropriate third party entity, the toll usage information.

16. The computer readable medium of claim 15, wherein the providing is based on a registered transport fleet of the toll rental entity.

17. The computer readable medium of claim 16 comprising instructions for matching, by the third party entity, toll violation information with the registered transport fleet.

18. A system for reassigning toll violation information, comprising:
a third party entity; and
a toll authority;
wherein the third party entity and the toll authority are communicably coupled;
wherein the toll authority collects toll usage information, wherein the toll usage information includes toll violation information;
wherein the toll authority matches transport user information to the toll usage information; and
wherein the toll authority reassigns a responsibility for the toll violation from the third party entity to a transport user.

19. The system of claim 18 comprising wherein the toll authority loads the toll usage information into a database based on a medium that the toll usage information was received.

20. The system of claim 18 wherein the toll authority provides, to an appropriate transport user, the toll usage information, wherein the toll usage information is at least one of: a violation, a warning, and a monetary amount to pay.

21. The system of claim 18, wherein the toll authority provides, to an appropriate transport owner, the toll usage information, wherein the toll usage information is at least one of: a violation, a warning, and a monetary amount to pay.
